(19) United States
(12) Patent Application Publication
(10) Pub. No.: US 2003/0127180 A1
(43) Pub. Date: Jul. 10, 2003

(54) Hinged label construction

(76) Inventor: Theodore T. Williams, Overland Park, KS (US)

Correspondence Address: HOVEY, WILLIAMS, TIMMONS & COLLINS, Suite 400, 2405 Grand Boulevard, Kansas City, MO, 64108, US

(21) Appl. No.: 10/043,568

(22) Filed: Jan. 10, 2002

(51) Int. Cl. B32B 31/00

(52) U.S. Cl. 156/247; 40/299.01; 40/638

(57) ABSTRACT

A hinged label construction has a top ply connected to an intermediate ply by an area of adhesive without the presence of release coating between the plies at one end, and an area of pressure sensitive adhesive and also a region of release coating at the other end between the plies. The top and intermediate plies are preferably carried by a carrier sheet provided with a release coating, so that after removal from the carrier sheet, the adhesive on the back surface of the intermediate ply may adhere to a receiving surface. The provision of adhesive at both ends between the top and intermediate plies and the presence of adhesive but not release coating at the opposite end therebetween, permits the top ply to be peeled from the intermediate ply but remain attached thereto for reading the indicia printed thereon in booklet fashion.

### BACKGROUND OF THE INVENTION

1. Field of the Invention

The present invention is concerned with a label which is applied having two or more plies which are adhesively connected and adherable to a receiving surface, and wherein printing may be applied so that printing on the back of an uppermost ply may be read in the manner of a booklet with a second or intermediate ply. More particularly, it is concerned with a label construction whereby the uppermost ply may be readily separated at one end from an intermediate ply but resists separation at another end to provide a hinged area whereby the uppermost and intermediate plies, when attached to a substrate, are easily read.

2. Description of the Prior Art

Label constructions using pressure sensitive adhesive are well known to manufacturers and consumers alike. Labels are typically provided with printing on one side and adhesive on the other. The labels are carried on a carrier sheet having a silicone release coating on the side facing the adhesive-coated side of the label. The label ply is peeled from the carrier sheet and applied on a surface, such as a product or sheet of paper. Such labels are economical, convenient and typically permanently adhere to the surface to which they are applied.

However, there are instances where the amount of information which must be conveyed on the label cannot be printed in an easily readable size on only one side, and the size of the label is constrained by the available area of the surface. As such, other coupon and label structures have been developed which provide a plurality of plies which may receive printing. One coupon structure is shown in U.S. Pat. No. 4,479,838 which provides several overlying plies. This structure increases the available area which may receive printing and thus provides an option for utilizing pressure sensitive labels in limited areas. It also has the benefit of economical manufacture by virtue of the simplicity of providing overlying layers without inherent problems of folding. One problem presented to users of this structure is the difficulty in maintaining integrity of the different plies after peeling away the top sheet. The top sheet of the U.S. Pat. No. 4,479,838 is provided with adhesive except at an edge or corner to facilitate peeling of the top sheet from the base sheet. Consequently, the top sheet is removed from the base sheet without provision for any specified area of retention between the top sheet and base sheet. For example, information such as instructions or warning labels may need to be maintained in an integrated setting, and the separation of different plies frustrates the user which must keep track of the separated parts or somehow attempt to reattach them after separation.

There has thus developed a need for an economical, useful label which is easily manufactured and applied to a surface, and which improves the utility of the label by integrating the plies to resist separation and improves the readability of the label by the user.

### SUMMARY OF THE INVENTION

These and other objects are largely achieved by the three ply label construction of the present invention. That is to say, the label construction of the present invention provides a hinge by an adhesive connection between the top label ply and the intermediate ply, is economical to manufacture because the construction requires no folding during manufacture and application and thus lessens the need for complicated handling equipment to maintain alignment, and is easy to use because the top and intermediate plies are readily separable from the carrier ply for application to a receiving surface.

In reference to the hinged label construction of the present invention, it broadly includes a top ply which receives printing on both sides thereof and a second, intermediate ply which has printing on its upper surface. The uppermost top ply is connected to the intermediate ply by pressure sensitive adhesive applied to the back side, preferably only at first and second ends of the top ply. The intermediate ply has greater adhesive connection to the top ply at one end and a relatively lesser adhesive connection at the other end. This lesser adhesive connection is most preferably provided by a release coating on the upper surface of the intermediate play facing the back side of the top ply, but only along a portion thereof, leaving an uncoated area which adhesively connects to the intermediate ply. Thus, the uncoated area acts as a hinge, whereby when one end of the top ply is lifted, the back side of the top ply may be read in juxtaposed position adjacent the indicia printed on the upper side of the intermediate ply. Alternative structures for lessening the adhesive connection at the other end could be provided by having an adhesive of lower strength at the other end, or by limiting the amount of adhesive applied at the other end by pattern coating or similar methods.

The top ply preferably has adhesive only at first and second ends of its back side, and may be provided with a marginal area at one or both ends which both facilitates separation of the top ply from the intermediate ply and also helps to avoid seepage of any adhesive outside the border of the superposed top and intermediate plies. The top ply and intermediate ply may be provided of paper, synthetic resin such as laminated polypropylene film or the like and coated with an ultraviolet clearcoat for water and scuff resistance and appearance. A carrier ply may be provided with a silicone release coating, whereby the back surface of the intermediate ply, which has a pressure sensitive adhesive coating, is readily removed from the carrier ply and the adhesive on the back surface of the intermediate ply remains with the intermediate ply after separation. The carrier ply is preferably common to a plurality of top and intermediate ply combinations, whereby a number of labels may be held on the carrier sheet until application to a receiving surface is desired.

As a result of the hinged label construction hereof, the top and intermediate plies are initially removable as a superposed set from the carrier ply and applied in concert to the receiving surface. The adhesive at each end of the junction between the top ply and the intermediate ply helps to resist separation or peeling away of the top ply until desired. Then, the top ply may be peeled back from the intermediate ply but remains attached thereto along a hinged area. This facilitates the ability of the user to read the indicia printed on the top and intermediate plies in concert with one another, and retention of the information thereon in the combination, but takes advantage of the ability to print and prepare the top and intermediate plies independently with consequent ease of handling during manufacture. The retention of the top and intermediate plies in concert after opening may be particularly important in the case of labels for insecticide, herbicide or the like, where warning information regarding use must be kept with the container and instructions for use are needed on a repeated basis.

These and other uses and advantages of the label construction hereof will be readily apparent to those skilled in the art with reference to the drawings and description which follow.

### BRIEF DESCRIPTION OF THE DRAWINGS

FIG. 1 is a perspective view of the hinged label construction of the present invention showing a plurality of labels each having a top ply and an intermediate ply adhesively retained on a carrier sheet, with the top layer of one label peeled back to show the location of printed indicia;

FIG. 2 is an enlarged plan view of the hinged label construction hereof, showing a corner of the top ply peeled away to show the cooperative placement of pressure sensitive adhesive on the back side of the top ply and an area of release coating on the upper surface of the intermediate ply; and

FIG. 3 is an enlarged vertical sectional view taken along line 3-3 of FIG. 2, showing in exaggerated thickness the layers of adhesive and coating applied to the top ply, intermediate ply and carrier sheet.

### DESCRIPTION OF THE PREFERRED EMBODIMENT

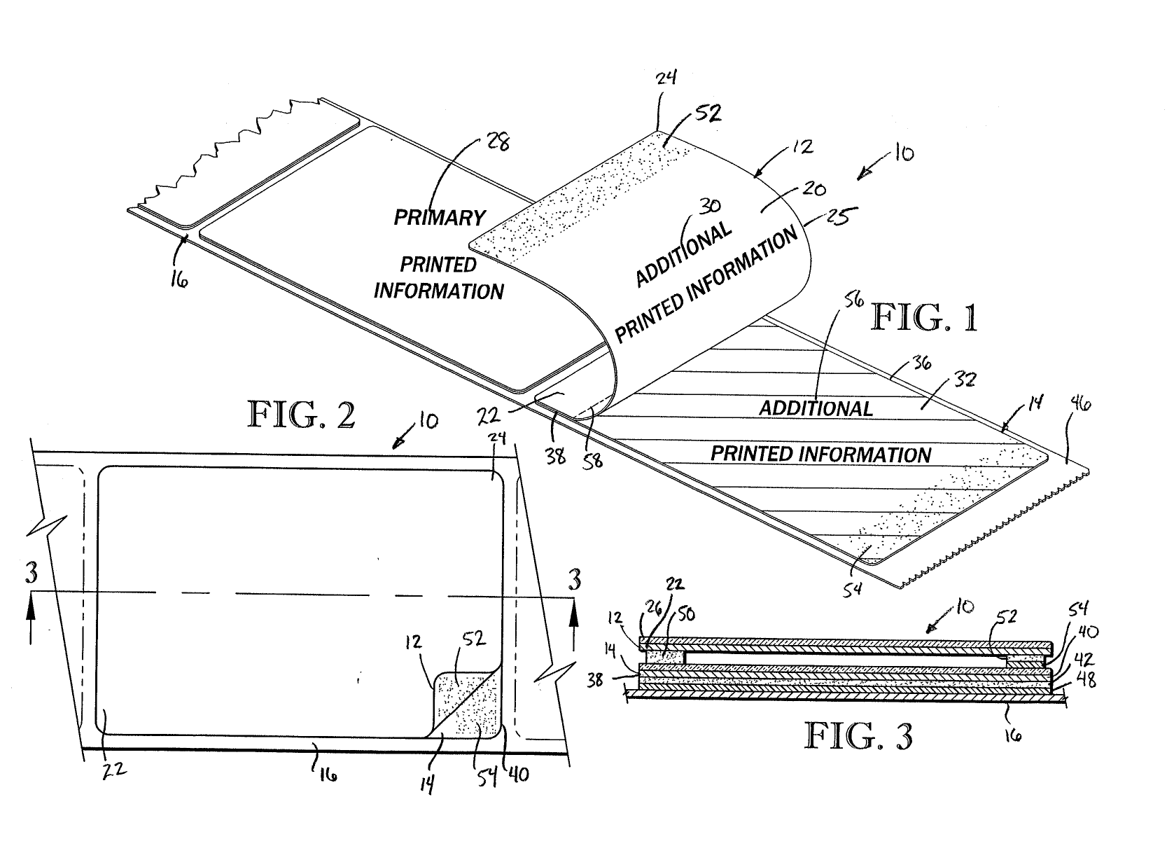

Referring now to the drawings, a label 10 in accord with the present invention is shown in FIGS. 1, 2 and 3 and broadly includes a top ply 12 and a second ply 14 which is initially positioned in superposed relationship to the top ply 12. The second ply 14 is initially adhesively coupled to carrier sheet 16. The second ply 14 and the first ply may be initially separated from the carrier sheet 16 as a unit and adhesively applied to a receiving surface.

In greater detail, the top ply 12, second ply 14 and carrier sheet 16 may be constructed of paper, synthetic resin such as laminated polypropylene film, or other sheet material. The top ply 12 has a top side 18, a bottom side 20, a first end 22, a second end 24 opposite the first end 22, and a surrounding edge 25. A UV cured clearcoat 26 shown in FIG. 3 may be applied to the top side 18 for appearance and water and scuff resistance. Indicia 28 are printed on the top side 18 and indicia 30 are also printed on the bottom side 20, as shown in FIG. 1.

The second ply 14 is positioned in registry with the top ply 12 and has an upper surface 32, a back surface 34, a surrounding margin 36, one end 38 and another end 40 opposite to the one end 38. The second ply 14 is positioned in superposed relationship with the top ply 12 such that the surrounding edge 24 is preferably substantially co-extensive and congruent with the surrounding margin 36, the first end 22 is over the one end 38 and the second end 24 is over the other end 40. Pressure sensitive adhesive is applied in a first region of adhesive coating 42 on the back surface 34 to enable the second ply 14 to readily adhere to a receiving surface. A variety of pressure sensitive adhesives suitable for use in the invention hereof are known to those skilled in the art, and an example of one such suitable adhesive Stock Number 17921 available from Northwest Coatings of Oak Creek, Wis. Indicia 44 is also printed on the upper surface 32 as shown in FIG. 1.

The carrier sheet 16 may carry a number of detachable labels 10 including the top ply 12 and the second ply 14 thereon as illustrated in FIG. 1 and FIG. 2. The carrier sheet has a top face 46 which may be provided with a silicone release coating layer 48. Such release coatings are well known to those skilled in the art.

A second region of adhesive coating 50 is provided adjacent the first end of the top ply 12 and the one end of the second ply 14. As may be seen in FIG. 3, this second region of adhesive coating 50, positioned between the bottom side 20 and the upper surface 32, does not have any silicone release coating to interfere with a relatively permanent adhesion between the top ply 12 and the second ply 14 in the second region of adhesive coating 50. The second region of adhesive coating 50 preferably extends less than one-fourth the length of the top ply 12 and the bottom ply 14, and thus not only provides a large area on the bottom side 20 and upper surface 32 for receiving indicia 30, but is thus able to act as a hinge when the top ply is peeled back and folded so that the bottom side 20 and the upper surface 32 are side-by-side in common facing orientation. The second region of adhesive coating 50 is preferably recessed inwardly from the surrounding margin and the surrounding edge as illustrated in FIG. 3 to lessen migration of adhesive therefrom during manufacture and use.

A third region of adhesive coating 52 is proved adjacent the second end 24 of the top ply 12 and the other end 40 of the second ply 14, and is shown in a rectangular configuration but may be of other shapes. The third region of adhesive coating 52 is confined so that it is discrete and longitudinally remote from the second region of adhesive coating 50. The third region of adhesive coating 52 is also recessed from the surrounding edge and surrounding margin to lessen migration of the adhesive, and also to facilitate the user's ability to grasp the top ly 12 and separate it from the second ply 14. A first region of silicone release coating 54 is applied between the other end 40 of the second ply 14 and the third region of adhesive coating 52, and is coextensive with the third region of adhesive coating 52, thus being of the same shape, size and commonly positioned. Thus, the third region of adhesive coating 52 remains with the top ply 12 at its second end 24 after the top ply 12 is peeled back from the second ply 14, and provides a lesser degree of adhesion between the top ply 12 and the second ply 14. The adhesive is preferably transparent and thus indicia 56 may be printed on the upper surface of the second ply 14 even extending to the first region of silicone release coating 54 and indicia 30 may extend below the third region of adhesive coating 52.

In use, a plurality of top ply 12 and second ply 14 combination labels in superposed relationship may be adhesively carried by the carrier sheet 16 in side-by-side relationship as shown in FIGS. 1 and 2. The labels 10 are provided for application to a surface, such as a product, bottle or other product package, rigid or flexible surface, or the like, by removing the top ply 12 and second ply 14 as a unit from the carrier sheet 16 and placing the second ply 14 in contact with the receiving surface either by hand or machine. The first region of adhesive coating 42 adheres to the receiving surface to provide a strong, substantially permanent connection between the second ply 14 and the receiving surface. Because the first region of adhesive coating 42 preferably covers substantially all of the back surface 34 of the second ply 14, and because of the absence of any release coating on the receiving surface, the adhesive bond between the second ply 14 is stronger than the adhesive bond between the first ply 12 and the second ply 14, especially in the area of the third region of adhesive coating 52. When the end user wishes to view the indicia on the bottom side 20 of the top ply 12 and on the back surface 32 of the second ply 14, the user may use a tab on the top ply 12 at the second or other end, and peel the top ply 12 back toward the first or one end. The relatively permanent adhesive connection between the top ply 12 and the second ply 14 at the second region of adhesive coating acts as a hinge, in that the top ply 12 tends to fold along a fold line 58 defined by the edge of the second region of adhesive coating 50 (which extends substantially transversely across the top ply 12 and the second ply 14 between their upper and lower edges as viewed in FIG. 2 in the same manner as third region of adhesive 54 shown in FIG. 1) most proximate the other end 24 or second end 40.

Thus, the label 10 may be easily constructed without the need for complicated folding machinery to handle a longer top ply by simply placing the top ply 12 in registry with the second ply 14. The top ply 12 and the second ply 14 remain with the receiving surface after application, so that important information is not lost or misplaced.

Although preferred forms of the invention have been described above, it is to be recognized that such disclosure is by way of illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of his invention as pertains to any apparatus not materially departing from but outside the literal scope of the invention as set out in the following claims.

1. A label comprising:
a top ply have an top side and a bottom side, a first end and an opposite second end and a surrounding edge, wherein indicia is printed on the top side and the bottom side;
a second ply having an upper surface and a back surface, a surrounding margin, one end and an opposite other end, wherein indicia is printed on the upper surface;
a first coating region of adhesive on the back surface of the second ply;
a second coating region of adhesive between the bottom side and the upper surface positioned at the first end of the top ply and the one end of the second ply;
a third coating region of adhesive between the bottom side and the upper surface positioned at the second end of the top ply and the other end of the second ply and holding the top ply in superposed relationship to the second ply; and
whereby a hinged connection between the top ply and the second ply is provided at the second coating region of adhesive, the adhesion between the top ply and the second ply at the second coating region being greater than the adhesion between the top ply and the second ply at the third coating region of adhesive.

2. A label as set forth in claim 1, wherein the adhesive of the second coating region of adhesive is the same as the adhesive in the third coating region of adhesive.

3. A label as set forth in claim 2, wherein a first release coating region is applied between the third coating region of adhesive and the bottom ply to facilitate separation of the top ply from the second ply at the second end of the top ply without extending to the second coating region of adhesive or interfering with the adhesion between the top ply and the second ply at the second coating region.

4. A label as set forth in claim 3, including a carrier sheet having a top face and a bottom face, and including a second release coating region applied between the top face and the bottom surface of the second ply for facilitating release of the top ply and the second ply as a unit from the carrier sheet.

5. A label as set forth in claim 1, wherein said third coating region of adhesive is recessed inwardly of said surrounding margin and said surrounding edge.

6. A label as set forth in claim 1, wherein said top ply is in registry with said second ply.

7. A method of using a label to a receiving surface, comprising the steps of:
providing a label having a top ply and a bottom ply positioned in superposed relationship in registry, the top ply having a first end, a second end, a top side having indicia printed thereon and a bottom side having indicia printed thereon, and a second ply having an upper surface having indicia printed thereon and a bottom surface, indicia printed on said top side, bottom side and top surface, a first region of adhesive coating applied on said bottom surface, a second region of adhesive coating applied between said top ply and said bottom ply at the first end and a third region of adhesive coating applied between the top ply and the bottom ply in spaced relationship from said second region of adhesive coating at the second end, the second region of adhesive coating providing greater adhesion between the top ply and the second ply than the adhesion between the top ply and the second ply at the third region of adhesive coating;
adhering the bottom surface of the second ply to a receiving surface;
separating the top ply from the bottom ply only at the second end while retaining an adhesive connection between the top ply and the bottom ply at the first end; and
moving the top ply to a position whereby the indicia on the back side of the top ply is adjacent to and may be read concurrently with the indicia on the upper surface of the second ply without moving the top ply.
